(19) United States
(12) Patent Application Publication
(10) Pub. No.: US 2014/0361941 A1
(43) Pub. Date: Dec. 11, 2014

(54) MULTI-TYPE ANTENNA

(71) Applicant: Qualcomm Incorporated, San Diego, CA (US)

(72) Inventors: Jatupum Jenwatanavet, San Diego, CA (US); Allen Minh-Triet Tran, San Diego, CA (US)

(21) Appl. No.: 13/911,923

(22) Filed: Jun. 6, 2013

(51) Int. Cl. H01Q 1/52

(52) U.S. Cl. CPC H01Q 1/52
USPC 343/722; 29/600

(57) ABSTRACT

Exemplary embodiments are related to multi-type antennas. A device may include an antenna and a ground plane. The device may further include a low-pass filter for coupling the antenna to the ground plane in a first mode of operation and isolating the antenna from the ground plane in a second, different mode of operation.

### BACKGROUND

1. Field

The present invention relates generally to antennas for wireless devices. More specifically, the present invention relates to embodiments for an antenna configured to operate as a monopole antenna in one mode and a planar inverted F antenna (PIFA) in another mode.

2. Background

Wireless communication devices have become smaller and more powerful in order to meet consumer needs and to improve portability and convenience. Consumers have become dependent upon wireless communication devices such as cellular telephones, personal digital assistants (PDAs), laptop computers, and the like. Consumers have come to expect reliable service, expanded areas of coverage, and increased functionality.

Wireless communication systems are widely deployed to provide various types of communication such as voice and data. A typical wireless data system, or network, provides multiple users access to one or more shared resources. A system may use a variety of multiple access techniques such as Frequency Division Multiplexing (FDM), Time Division Multiplexing (TDM), Code Division Multiplexing (CDM), and others.

It is widely known that antennas can be used to transmit and receive electromagnetic radiation of certain frequencies to carry signals. That is, an antenna is typically designed to transmit and receive signals over a range of carrier frequencies. The antenna is a critical part of all wireless communications devices. Typically, antennas should meet very stringent requirements regarding size, efficiency, wide bandwidth of operation, ability to function efficiently when space is at a premium and a low manufacturing cost. Small space, usually available for an antenna, dictates antenna choice, which may be a monopole antenna, a planar inverted-F antenna (PIFA), a printed disc antenna or a patch antenna.

A need exists for an enhanced antenna. More specifically, a need exists for embodiments related to a multi-type antenna for portable electronic devices.

### BRIEF DESCRIPTION OF THE DRAWINGS

FIG. 1A illustrates a device, according to an exemplary embodiment of the present invention.

FIG. 1B depicts another device, in accordance with an exemplary embodiment of the present invention.

FIG. 2A illustrates another device including an antenna corner structure, in accordance with an exemplary embodiment of the present invention.

FIG. 2B illustrates another device including an antenna corner structure, according to an exemplary embodiment of the present invention.

FIGS. 3A and 3B illustrate a device including an antenna coupled to a printed wiring board, according to an exemplary embodiment of the present invention.

FIG. 4A depicts a device including a low-pass filter, a matching circuit, an antenna, and a ground plane, in accordance with an exemplary embodiment of the present invention.

FIG. 4B illustrates the device of FIG. 4A during one mode of operation, in accordance with an exemplary embodiment of the present invention.

FIG. 4C illustrates the device of FIG. 4A during another mode of operation, according to an exemplary embodiment of the present invention.

FIG. 4D depicts another device, according to an exemplary embodiment of the present invention.

FIG. 4E illustrates a device including a plurality of corner structures, in accordance with an exemplary embodiment of the present invention.

FIG. 5 depicts a simulation model, according to an exemplary embodiment of the present invention.

FIG. 6 is a plot depicting S-parameter data of the model of FIG. 5.

FIG. 7 is another illustration of a device, in accordance with an exemplary embodiment of the present invention.

FIG. 8A is a plot depicting measured return loss data of device in a frequency band, according to an exemplary embodiment of the present invention.

FIG. 8B is another plot depicting measured return loss data of device in another frequency band, according to an exemplary embodiment of the present invention.

FIG. 9 is a plot depicting efficiency of an antenna in low frequency band, in accordance with an exemplary embodiment of the present invention.

FIG. 10A is another plot depicting efficiency of an antenna in another frequency band, in accordance with an exemplary embodiment of the present invention.

FIG. 10B is yet another plot depicting efficiency of an antenna in another frequency band, in accordance with an exemplary embodiment of the present invention.

FIG. 11 is a flowchart depicting a method, in accordance with an exemplary embodiment of the present invention.

FIG. 12 is a flowchart depicting another method, in accordance with an exemplary embodiment of the present invention.

FIG. 13 illustrates a device including at least one antenna, in accordance with an exemplary embodiment of the present invention.

### DETAILED DESCRIPTION

The detailed description set forth below in connection with the appended drawings is intended as a description of exemplary embodiments of the present invention and is not intended to represent the only embodiments in which the present invention can be practiced. The term “exemplary” used throughout this description means “serving as an example, instance, or illustration,” and should not necessarily be construed as preferred or advantageous over other exemplary embodiments. The detailed description includes specific details for the purpose of providing a thorough understanding of the exemplary embodiments of the invention. It will be apparent to those skilled in the art that the exemplary embodiments of the invention may be practiced without these specific details. In some instances, well-known structures and devices are shown in block diagram form in order to avoid obscuring the novelty of the exemplary embodiments presented herein.

It remains challenging to design small antennas for portable wireless devices, which may require antennas to operate in multiple frequency bands. In conventional antenna design, an antenna radiating element should be positioned from a radio-frequency (RF) ground of a circuit board at an ample distance (often referred to as a “keep out area”) so that the antenna may function properly. Further, as will be appreciated, it is problematic to traditionally design a wide band antenna when the keep out area is minimal.

Antenna types that may be used for small portable wireless devices include monopole type antennas and PIFA type antenna. In principle, monopole antennas provide more bandwidth than a PIFA antenna, however monopole antennas require larger keep out area whereas PIFA antennas are less sensitive to keep out area.

Exemplary embodiments, as described herein, are directed to devices and methods related to a multi-type antenna. According to one exemplary embodiment, a device may include an antenna and a ground plane. The device may further include a low-pass filter for coupling the antenna to the ground plane in a first mode of operation and isolating the antenna from the ground plane in a second, different mode of operation. In accordance with another exemplary embodiment of the present invention, a device may include a printed board, and an antenna coupled to the printed board. The antenna may extend along a first outer surface and a second outer surface of the printed board, wherein the second surface is substantially perpendicular to the first surface.

According to another exemplary embodiment, the present invention includes methods for operating a multi-type antenna. Various embodiments of such a method may include coupling an antenna having a first portion extending in a first direction and a second portion extending in a second direction substantially perpendicular to the first surface to a ground plane in a first mode of operation. The method may further include isolating the antenna from the ground plane in a second, different mode of operation. In accordance with another exemplary embodiment of the present invention, a method may include electrically coupling an antenna to a ground plane via a filter while operating in one frequency band. The method may also include electrically isolating the antenna from the ground plane via the filter while operating in another, higher frequency band.

Other aspects, as well as features and advantages of various aspects, of the present invention will become apparent to those of skill in the art though consideration of the ensuing description, the accompanying drawings and the appended claims.

According to various exemplary embodiments of the present invention, an antenna may be configured as a monopole antenna while operating in one mode (e.g., a high frequency mode) and a PIFA antenna while operating in another mode (e.g., a low frequency mode). It is noted that, according to one or more embodiments of the present disclosure, the PIFA antennas described herein may comprise a wire inverted-F antenna (WIFA) or a monopole antenna with a loaded inductor. The antenna may be implemented as a corner structure antenna, as described more fully below, with a low pass filter coupling the antenna to ground (e.g., via a ground contact) while operating as a PIFA antenna. As a result, at low frequency (e.g., 700-960 MHz), the corner structure antenna may behave as a PIFA antenna whereas at high frequency (e.g., 1700-6000 MHz), the corner structure antenna may behave as a monopole antenna.

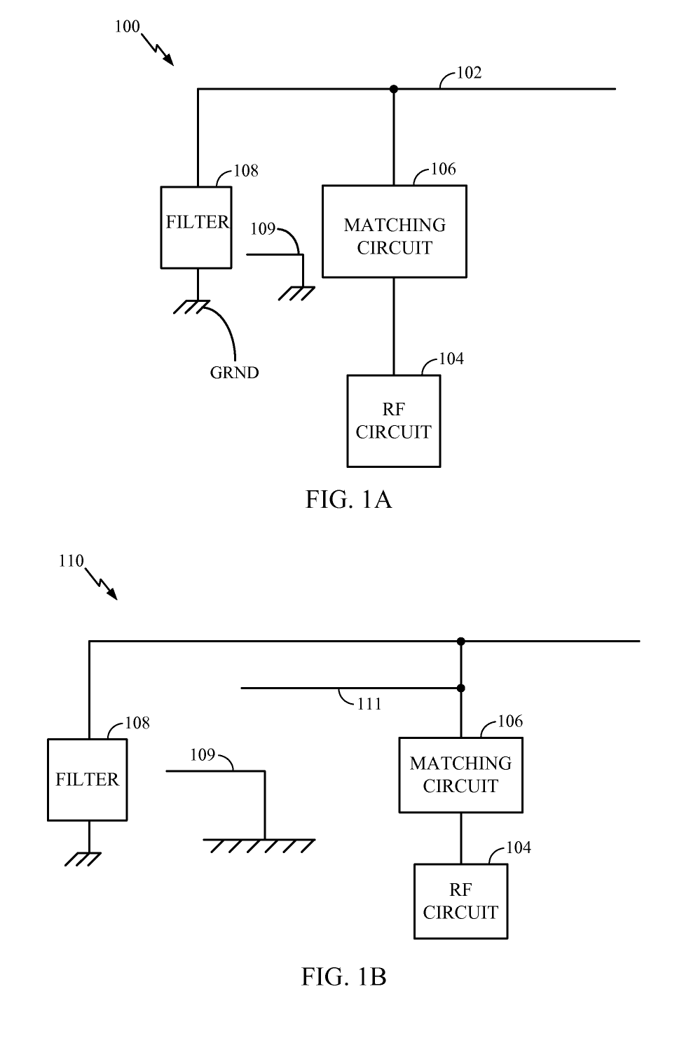

FIG. 1A depicts a device 100, in accordance with an exemplary embodiment of the present invention. Device 100 includes an antenna 102, a radio-frequency (RF) circuit 104, a matching circuit 106, and a filter 108. As illustrated in FIG. 1, filter 108 may be coupled between a ground voltage GRND and antenna 102. Further, matching circuit 106 may be coupled between RF circuit 104 and antenna 102. As will be described more fully below, during high frequency operation (i.e., monopole type operation), filter 108 may function as an open circuit. Further, during low frequency operation (i.e., PIFA type operation), filter 108 may function as a short circuit.

Moreover, device 100 includes a parasitic antenna 109, which may positioned near an antenna feed and matching circuit 106 and may be coupled to a ground of a printed board (e.g. printed wiring board). Parasitic antenna 109 may enable device 100 to operate in additional frequency bands (e.g., covering frequencies between 2700 and 6000 MHz).

FIG. 1B depicts another device 110, according to another exemplary embodiment. In addition to filter 108, matching circuit 106, and RF circuit 104, device 110 includes an additional antenna arm 111, which may widen the bandwidth and/or enable the antenna to cover additional frequency bands.

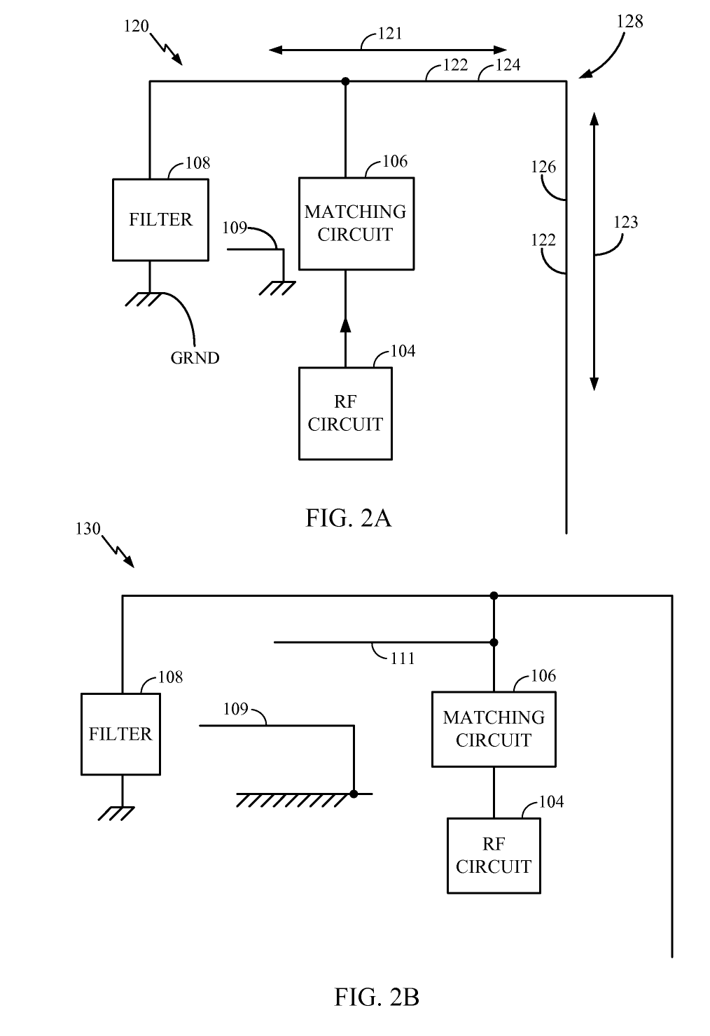

FIG. 2A depicts another device 120, according to an exemplary embodiment of the present invention. Similar to device 100, device 120 includes RF circuit 104, matching circuit 106, and filter 108. Further, device 120 includes antenna 122 having a first portion 124 extending in a first direction (i.e., as indicated by arrow 121), and a second portion 126 extending in a second direction (i.e., as indicated by arrow 123), and a corner portion 128 connecting first portion 124 and second portion 126. As an example, and as illustrated in FIG. 2, first portion 124 and second portion 126 may extend in substantially perpendicular directions. An antenna, which includes a corner portion, may also be referred to herein as a “corner structure” or a “corner antenna.” As illustrated in FIG. 2A, filter 108 may be coupled between a ground voltage GRND and antenna 122. Further, matching circuit 106 may be coupled between RF circuit 104 and antenna 122. As noted above, during high frequency operation (i.e., monopole type operation), filter 108 may operate as an open circuit. Thus, during the high frequency operation, antenna 122 is coupled to RF circuit 104 via matching circuit 106; however, antenna 122 is isolated from the ground voltage. Further, during low frequency operation (i.e., PIFA type operation), filter 108 may operate as a short circuit (i.e., antenna 122 is shorted to the ground voltage). Therefore, during the low frequency operation, antenna 122 is coupled to each of RF circuit 104 (i.e., via matching circuit 106) and the ground voltage. FIG. 2B depicts a device 130, which is similar to device 120 and includes parasitic antenna 109 and additional antenna arm 111.

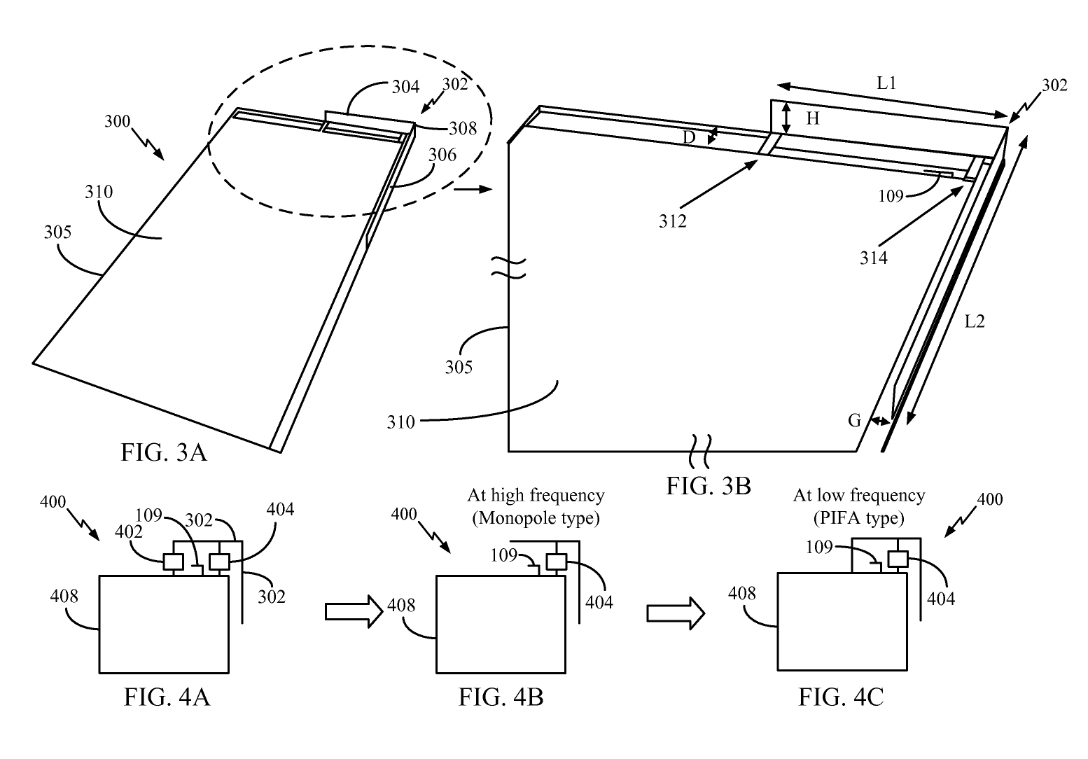

FIGS. 3A and 3B illustrate a device 300, in accordance with an exemplary embodiment of the present invention. Device 300 includes an antenna 302 coupled to a printed board 305. Printed board 305 may comprise, for example only, a “printed circuit board” (PCB), a printed wiring board (PWB), or any combination thereof. By way of example only, printed board 305 may have a length of substantially 103 millimeters and a width of substantially 55 millimeters. As illustrated in each of FIGS. 3A and 3B, antenna 302 includes a first portion 304 and a second portion 306, and a corner portion 308, which connects first portion 304 and second portion 306. In this illustrated example, antenna 302 comprises a corner structure extending along two sides and a corner of printed board 304. Further, by way of example only, a height H of antenna may be substantially 5 millimeters. Moreover, a length L1 of first portion 304 may be, for example, substantially 25 millimeters and a length L2 of second portion 306 may be substantially 50 millimeters, for example.

In addition, device 300 includes a ground plane 310 positioned on printed board 305. As will be understood by a person having ordinary skill in the art, a ground plane on a printed board, such as a printed wiring board, may comprise an area of foil, for example, connected to a circuit's ground point (e.g., one terminal of a power supply). The ground plane may function as a return path for current from one or more circuit components. A ground plane, which may be any suitable, is often made as large as possible to cover most of an area of a printed board that is not occupied by circuit traces. In multilayer printed boards, a ground plane is often a separate layer covering the entire board.

As depicted in FIG. 3B, first portion 304 of antenna 302 may be spaced from ground plane 310 by a distance D, which may be, for example only, 5 millimeters. Furthermore, second portion 306 of antenna 302 may be spaced from ground plane 310 by a distance G, which may be, for example only, 2 millimeters. Device 300 may further include a contact 312 for coupling antenna 302 to a low-pass filter (not shown in FIG. 3A or 3B) and a contact 314 for coupling antenna 302 to an antenna feed (not shown in FIG. 3A or 3B) via, for example, a matching circuit. As a more specific example, contact 314 may be configured for coupling antenna 302 to an RF circuit (e.g., RF circuit 104; see FIG. 2) via a matching circuit (e.g., matching circuit 106; see FIG. 2). It is noted that, in the exemplary embodiment illustrated in FIGS. 3A and 3B, contact 314 is positioned proximate the corner of antenna 302 and the corner of printed board 305, and contact 312 is adequately spaced from the corner of antenna 302 and the corner of printed board 305. Device 300 further includes parasitic antenna 109.

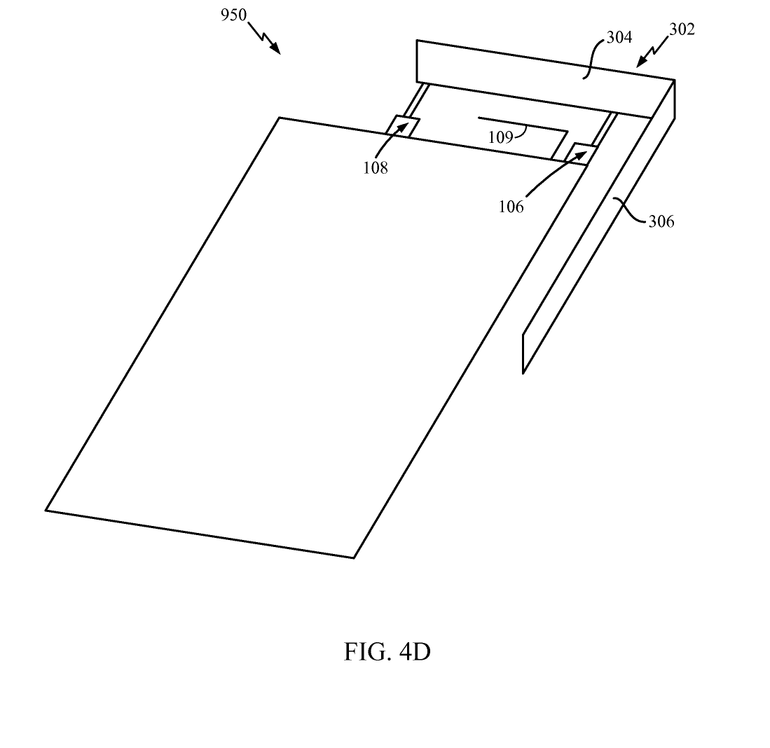

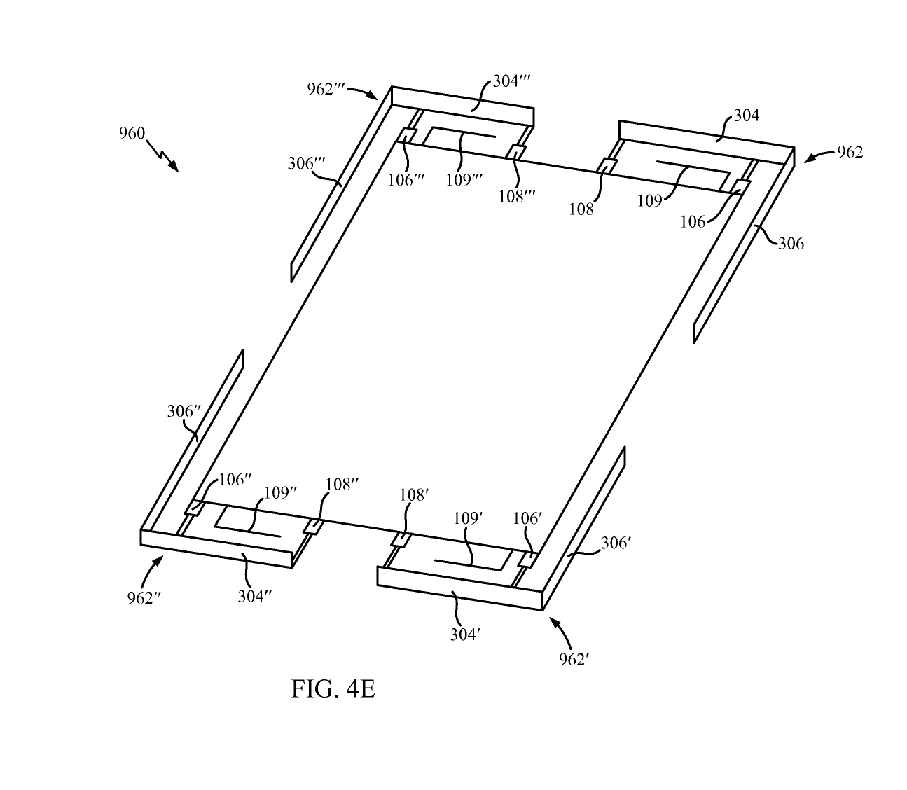

FIG. 4A illustrates a device 400, according to an exemplary embodiment of the present invention. Device 400 includes a low-pass filter 402, a matching circuit 404, antenna 302, and parasitic antenna 109. Further, device 400 includes a structure 408, which may comprise a ground plane of an electronic device. FIG. 4B illustrates device 400 operating at high frequency (e.g., 1700-6000 MHz) and FIG. 4C illustrates device 400 at a low frequency (e.g., 700-960 MHz). As will be appreciated by a person having ordinary skill in the art, at high frequencies, antenna 302 may not be coupled to ground plane (i.e., antenna 302 may be isolated from ground plane), as shown in FIG. 4. Further, at low-frequencies, antenna 302 may be shorted to ground plane 408, as shown in FIG. 4C.

FIG. 4D illustrates another device 450, in accordance with an exemplary embodiment of the present invention. Similar to device 300, device 450 includes an antenna 302 including first portion 304 and second portion 306, parasitic antenna 109, filter 108, and matching circuit 106. Further, each portion (i.e., first portion 304 and second portion 306) of antenna 302 may be physically separated from printed board 305. In this illustrated embodiment, filter 108 and matching circuit 106 may be connected to a metal bezel directly, wherein the metal bezel may function as antenna 302.

FIG. 4E illustrates a device 480 including a plurality of corner structures, in accordance with an exemplary embodiment of the present invention. Device 480 includes corner structures 962, 962′, 962″, and 962″′. Each corner structure 962/962′/962″/962″′ includes an antenna having a first portion 304/304′/304″/304″′ and a second portion 306/306′/306″/306″′. Further, each corner structure 962/962′/962″/962″′ includes a parasitic antenna 109/109′/109″/109″′, a filter 108/108′/108″/108″′ and a matching circuit 106/106′/106″/106″′.

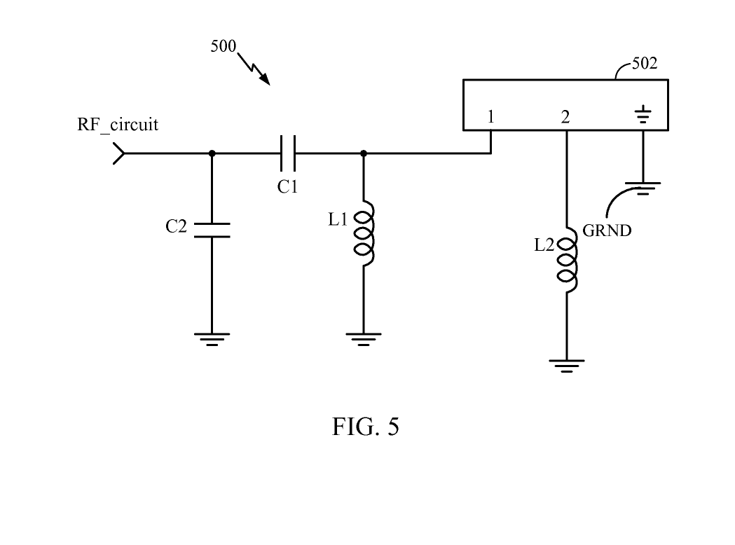

FIG. 5 depicts an example matching circuit model 500 of a device (e.g., device 300). Circuit model 500 includes capacitors C1 and C2 and inductor L1, which may be coupled between RF circuitry and a first port 1 (i.e., contact 314 in FIG. 3B). Circuit model 500 further includes an inductor L2 serving as low pass filter coupled between a ground voltage and a second port 2 (i.e., contact 312 in FIG. 3B). In addition, model 500 includes a ground port coupled to a ground voltage GRND. During simulation, an antenna, which may comprise inductor L2, may be coupled to ground voltage GRND at low frequencies and isolated from ground voltage GRND at high frequencies.

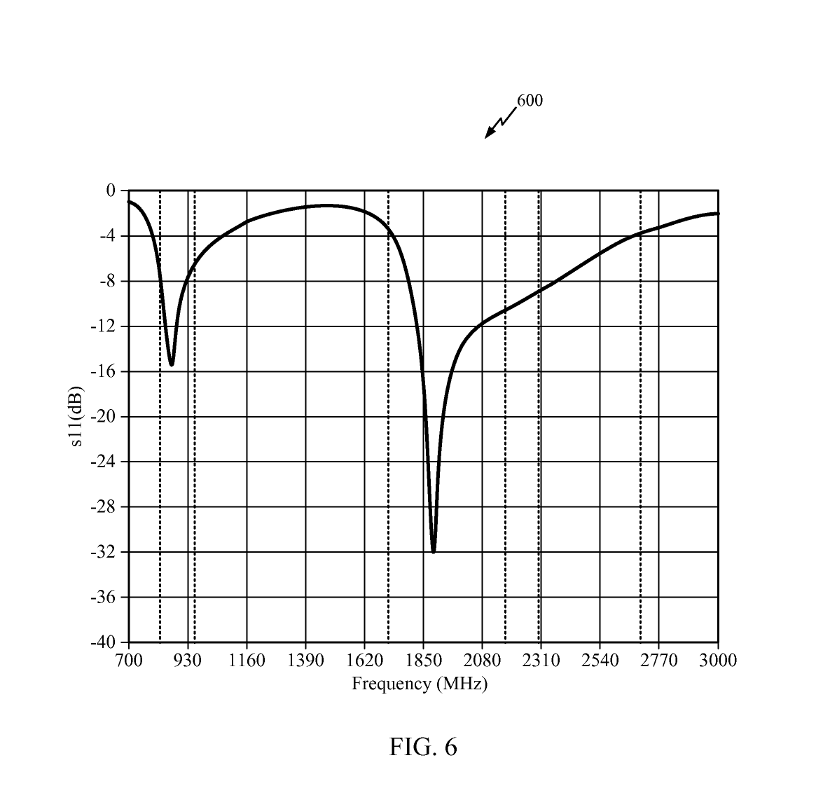

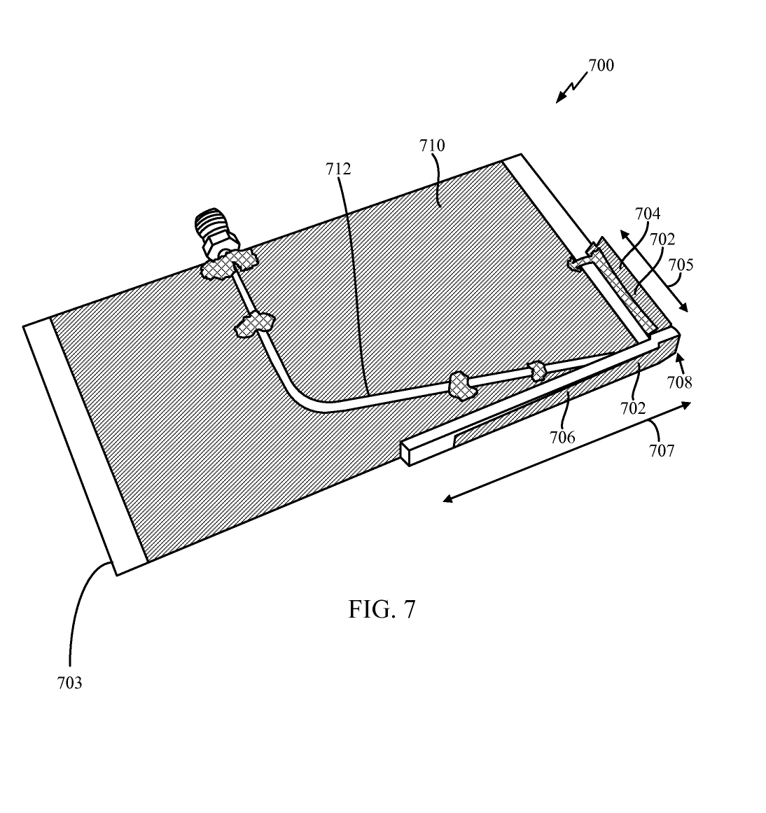

FIG. 6 is a simulation plot 600 illustrating S-parameter data for model 500 (see FIG. 5). Plot 600 shows simulated return loss (S11) of antenna over frequency. As shown in the plot, the return loss of antenna in low frequency band (824-960 MHz) is less than −8 dB and the return loss of antenna in high frequency band (1700-2700 MHz) is less than −6 dB, confirming that the antenna is well matched over multiple wide frequency band. Note that in general, the antenna can be designed to work in the lower frequency to cover 700 MHz and in the higher frequency to cover more than 2700 MHz as well but in this case, due to the above mentioned minimal size of antenna keep out area, it is optimized at 824-960 MHz and 1700-2700 MHz in this simulation.

FIG. 7 is another illustration of device (i.e., a prototype) 700, according to an exemplary embodiment of the present invention. Device 700 includes an antenna 702 configured as a corner structure and coupled to a printed board 703. More specifically, antenna 702 includes a first portion 704 extending in a first direction (i.e., as indicated by arrow 705), a second portion 706 extending in a second direction (i.e., as indicated by arrow 707), and a corner portion 708 wherein first portion 704 and second portion 706 extend from corner portion 708. It is noted that antenna 702 may comprise a unitary structure, or a structure including multiple units formed together. Further, device 700 includes a ground plane 710 and coaxial cable 712, which is configured for coupling to RF circuitry (not shown in FIG. 7). It is noted that device 700 may also include a parasitic antenna, such as parasitic antenna 109 (not shown in FIG. 7; see e.g., FIG. 3B).

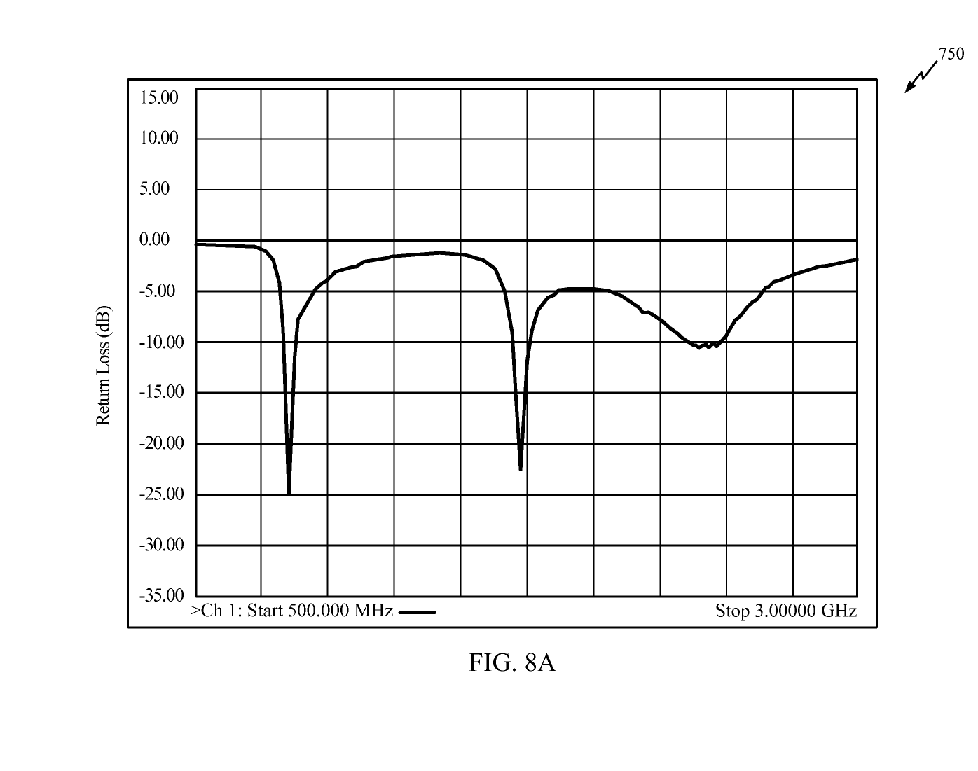

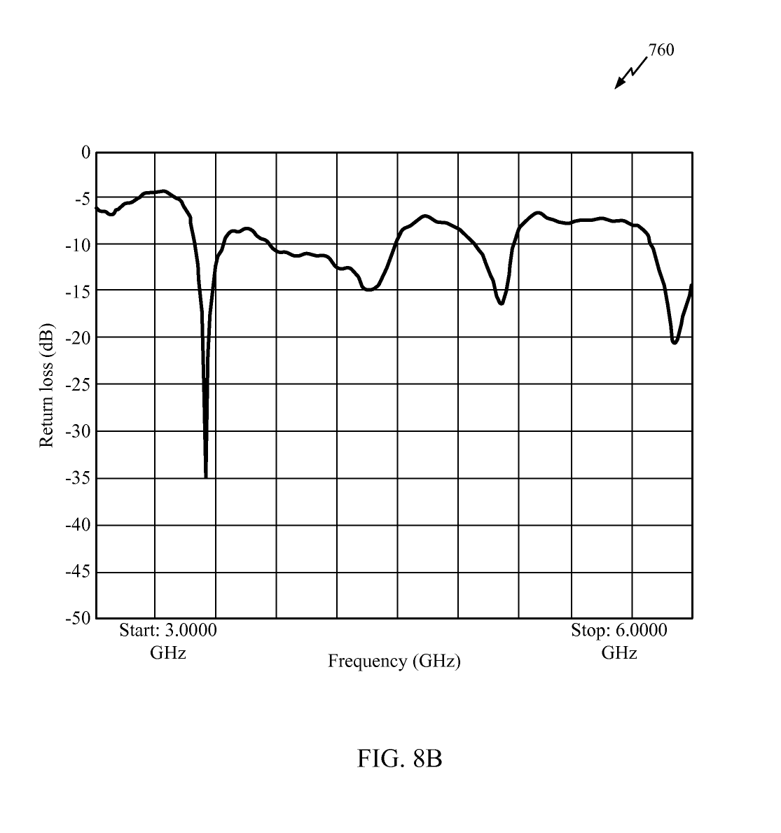

FIG. 8A depicts a plot 750 depicting measured return loss data (i.e., from 500 MHz to 3000 MHz) of device 700 illustrated in FIG. 7. As shown in plot 750, the measured return loss is similar to the simulated return loss, as the return loss in both low band and high band is better than -6 dB. Further, FIG. 8B depicts a plot 760 depicting measured return loss data (i.e., from 3000 MHz to 6000 MHz) of device 700 illustrated in FIG. 7.

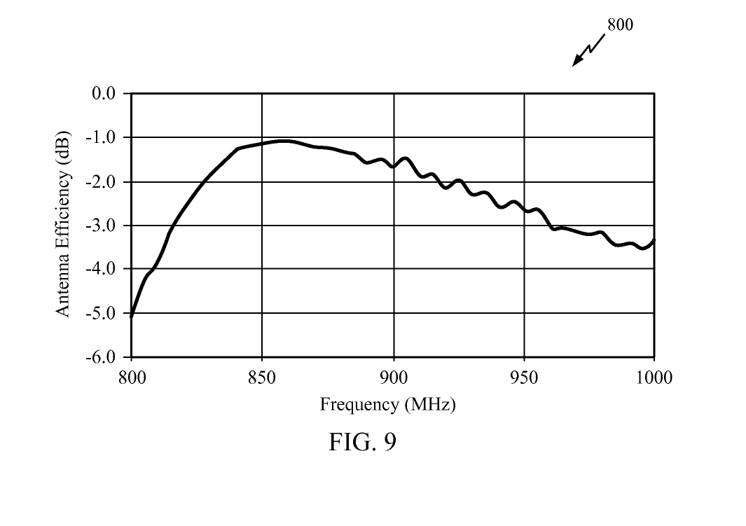

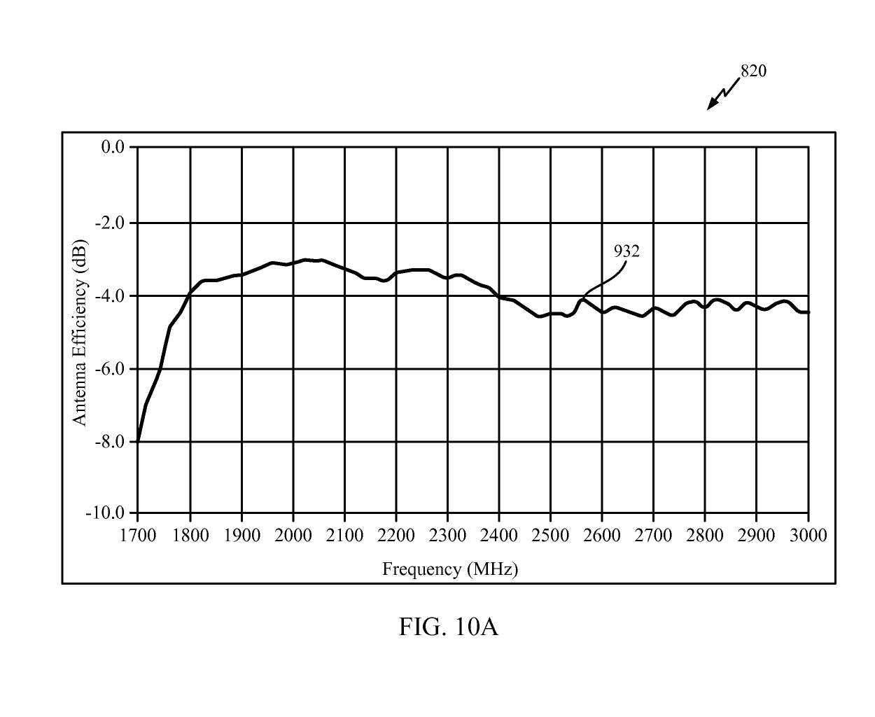

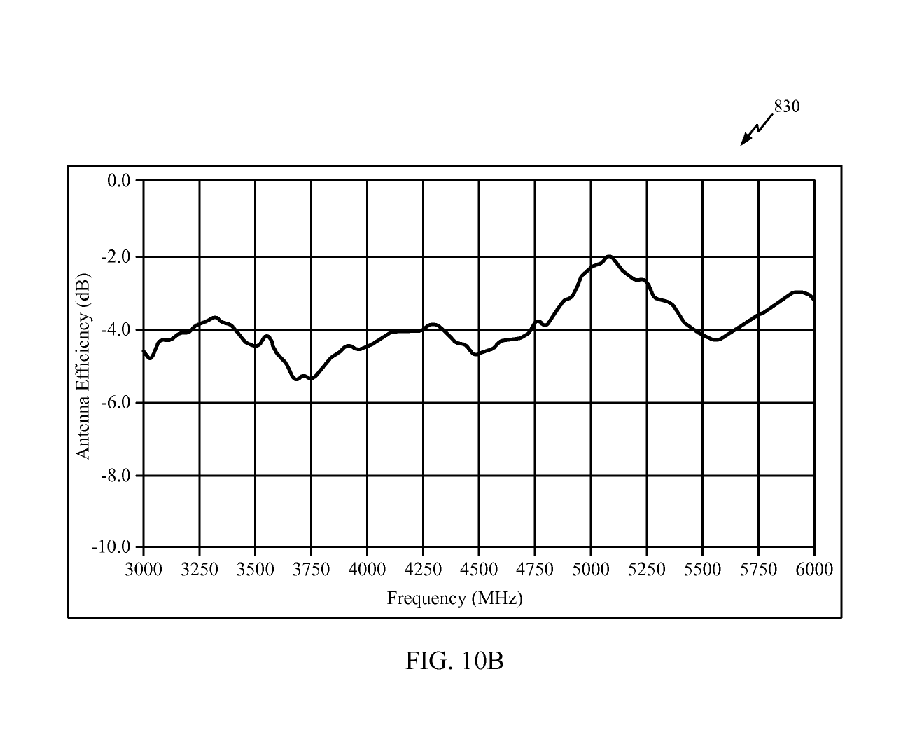

FIG. 9 depicts another plot 800 depicting efficiency of antenna 702 of device 700 within a low band (e.g., 824-960 MHz). FIGS. 10A and 10B are plots depicting efficiency of antenna 702 of device 700 within a high band. More specifically, FIG. 10A depicts a plot 820 depicting efficiency of antenna 702 of device 702 between 1700-3000 MHz and FIG. 10B depicts yet another plot 830 depicting efficiency of antenna 702 of device 702 between 3000-6000 MHz.

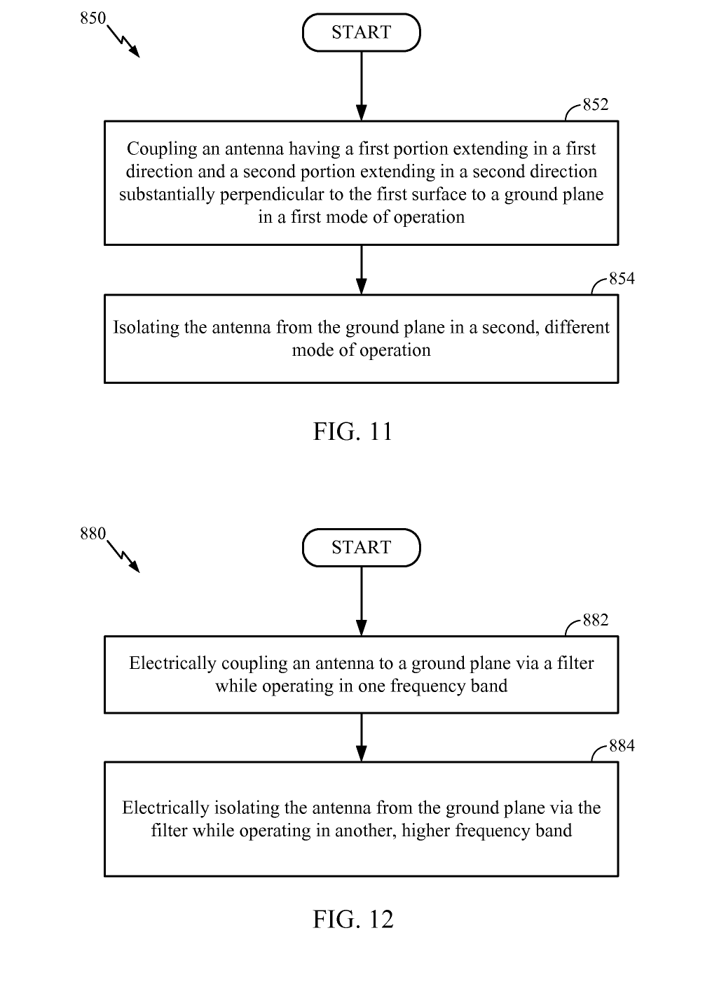

FIG. 11 is a flowchart illustrating a method 850, in accordance with one or more exemplary embodiments. Method 850 may include coupling an antenna having a first portion extending in a first direction and a second portion extending in a second direction substantially perpendicular to the first surface to a ground plane in a first mode of operation (depicted by numeral 852). Method 850 may also include isolating the antenna from the ground plane in a second, different mode of operation (depicted by numeral 854).

FIG. 12 is a flowchart illustrating another method 880, in accordance with one or more exemplary embodiments. Method 880 may include electrically coupling an antenna to a ground plane via a filter while operating in one frequency band (depicted by numeral 882). Method 880 may further include electrically isolating the antenna from the ground plane via the filter while operating in another, higher frequency band (depicted by numeral 884).

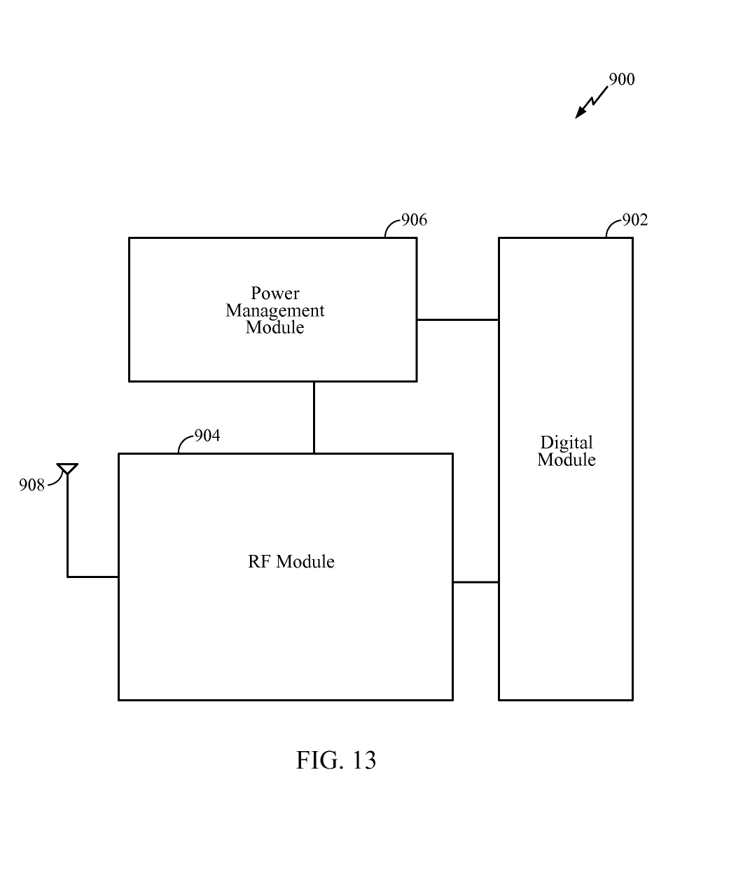

FIG. 13 is a block diagram of an electronic device 900, according to an exemplary embodiment of the present invention. According to one example, device 900 may comprise a portable electronic device, such as a mobile telephone. Device 900 may include various modules, such as a digital module 902, an RF module 904, and power management module 906. Digital module 902 may comprise memory and one or more processors. RF module 904, which may comprise RF circuitry, such as RF circuit 104 (see e.g., FIGS. 1 and 2), may include a transceiver including a transmitter and a receiver and may be configured for bi-directional wireless communication via an antenna 908. In general, wireless communication device 900 may include any number of transmitters and any number of receivers for any number of communication systems, any number of frequency bands, and any number of antennas. According to one exemplary embodiment, antenna 908 may comprise one or more of antennas 102, 122, 302, and 702, as described above with reference to FIGS. 1-7.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the exemplary embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the exemplary embodiments of the invention.

The various illustrative logical blocks, modules, and circuits described in connection with the exemplary embodiments disclosed herein may be implemented or performed with a general purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosed exemplary embodiments is provided to enable any person skilled in the art to make or use the present invention. Various modifications to these exemplary embodiments will be readily apparent to those skilled in the art, and the generic principles defined herein may be applied to other embodiments without departing from the spirit or scope of the invention. Thus, the present invention is not intended to be limited to the exemplary embodiments shown herein but is to be accorded the widest scope consistent with the principles and novel features disclosed herein.

What is claimed is:

1. A device, comprising:
an antenna;
a ground plane; and
a low-pass filter for coupling the antenna to the ground plane in a first mode of operation and isolating the antenna from the ground plane in a second, different mode of operation.

2. The device of claim 1, the first mode of operation comprising a low-frequency mode of operation and the second mode of operation comprising a high-frequency operation.

3. The device of claim 2, the high-frequency mode of operation comprising a frequency range of substantially 1700 megahertz (MHz) to 6000 MHz and the low-frequency mode of operation comprising a frequency range of substantially 700 MHz to 960 MHz.

4. The device of claim 1, further comprising an antenna feed including a matching circuit for coupling a radio-frequency (RF) circuit to the antenna.

5. The device of claim 1, further comprising:
a radio-frequency (RF) circuit; and
a matching circuit coupled between the RF circuit and the antenna.

6. The device of claim 1, the antenna configured as one of a planar inverted-F antenna (PIFA), a wire inverted-F antenna (WIFA), and a monopole with loaded inductor antenna during the first mode of operation and a monopole antenna during the second, different mode of operation.

7. The device of claim 1, further comprising a parasitic antenna coupled to the ground plane.

8. A device, comprising:
a printed board; and
an antenna coupled to the printed board and extending along a first outer surface and a second outer surface of the printed board, the second surface substantially perpendicular to the first surface.

9. The device of claim 8, the antenna configured to couple to a ground plane via a low-pass filter during a first mode of operation.

10. The device of claim 9, the first mode of operation comprising a frequency range of substantially 700 megahertz (MHz) to 960 MHz.

11. The device of claim 8, further comprising a low-pass filter configured to couple to the antenna to a ground plane during one mode of operation and isolate the antenna from the ground plane during another, different mode of operation.

12. The device of claim 11, the low pass filter comprising a single inductor or an inductor in parallel with a capacitor.

13. The device of claim 8, the antenna electrically coupled to a radio-frequency (RF) circuit via a matching circuit.

14. The device of claim 8, the antenna configured as a PIFA antenna during a first mode of operation and monopole antenna during a second, different mode of operation.

15. The device of claim 8, further comprising a housing including the antenna.

16. The device of claim 15, the housing comprising one of a bezel and a frame.

17. The device of claim 15, further comprising a plurality of additional antennas, wherein each corner of the printed board includes an antenna of the plurality of additional antennas extending along adjacent, perpendicular surfaces of the printed board.

18. A method, comprising:
coupling an antenna having a first portion extending in a first direction and a second portion extending in a second direction substantially perpendicular to the first surface to a ground plane in a first mode of operation; and
isolating the antenna from the ground plane in a second, different mode of operation.

19. The method of claim 18, the coupling an antenna to a ground plane in a first mode of operation comprising coupling the antenna to the ground plane during the first mode of operation having a frequency range of substantially 700 megahertz (MHz) to 960 MHz.

20. The method of claim 18, the isolating the antenna from the ground plane in a second, different mode of operation comprising isolating the antenna from the ground plane in the second, different mode of operation having a frequency range of substantially 1700 megahertz (MHz) to 6000 MHz.

21. The method of claim 18, the coupling an antenna to a ground plane in a first mode of operation comprising coupling the antenna to the ground plane via a low-pass filter configured to operate as a short circuit during the first mode of operation.

22. The method of claim 18, the isolating the antenna from the ground plane in a second, different mode of operation comprising isolating the antenna from the ground plane via a low-pass filter configured to operate as an open circuit during the second, different mode of operation.

23. A method, comprising:
electrically coupling an antenna to a ground plane via a filter while operating in one frequency band; and
electrically isolating the antenna from the ground plane via the filter while operating in another, higher frequency band.

24. The method of claim 23, the electrically coupling an antenna to a ground plane via a filter comprising electrically coupling the antenna to the ground plane while the antenna is operating as a planar inverted F antenna (PIFA) type antenna.

25. The method of claim 23, the electrically isolating the antenna from the ground plane via the filter comprising electrically isolating the antenna from the ground plane while the antenna is operating as monopole type antenna.

26. The method of claim 23, the electrically coupling an antenna to a ground plane via a filter comprising electrically coupling the antenna to the ground plane via a low-pass filter configured to operate as a short circuit in the one frequency band.

27. The method of claim 23, the electrically isolating the antenna from the ground plane via the filter comprising electrically isolating the antenna from the ground plane via a low-pass filter configured to operate as an open circuit in the another, higher frequency band.

28. A device, comprising:
means for coupling an antenna having a first portion extending in a first direction and a second portion extending in a second direction substantially perpendicular to the first surface to a ground plane in a first mode of operation; and
means for isolating the antenna from the ground plane in a second, different mode of operation.

29. A device, comprising:
means for electrically coupling an antenna to a ground plane via a filter while operating in one frequency band; and
means for electrically isolating the antenna from the ground plane via the filter while operating in another, higher frequency band.
